(19) United States
(12) Patent Application Publication
(10) Pub. No.: US 2009/0100107 A1
(43) Pub. Date: Apr. 16, 2009

(54) ACCIDENT DATA FOR THE SEMANTIC WEB

(75) Inventors: Ludwig BENNER, Jr., Oakton, VA (US); William David Carey, Centreville, VA (US)

Correspondence Address: Mark C. Comtois;Duane Morris LLP, Suite 1000, 505 9th Street, N.W., Washington, DC, 20004-2166, US

(73) Assignee: Starline Software, Ltd., Oakton, VA (US)

(21) Appl. No.: 12/252,012

(22) Filed: Oct. 15, 2008

Related U.S. Application Data
(60) Provisional application No. 60/960,813, filed on Oct. 15, 2007.

(51) Int. Cl. G06F 17/30

(52) U.S. Cl. 707/104.1; 707/E17.046

(57) ABSTRACT

Disclosed is a novel method and tabular display for presenting events in an investigation including obtaining blocks of information that include a description of an action and associating the information with other information to form logical groupings. The associations include input and output action associations. The method and tabular display also include forming event sets containing the associated group which include at least an input action, a focus action, or an output action and arranging the event sets in chronological order and displaying the event sets in rows over an input action column, a focus action column and an output action column.

### BACKGROUND

The need to improve adaptive dynamic behavior of socio-technical systems through investigations of accidents, before and after the accidents occur, has long been of interest. Some organizations have established lessons-learned “centers” or operated feedback systems. These centers or system employ mishap data inputs and/or inputs from other sources to generate databases with lessons learned for use in exemplary organizations or by personnel.

Current investigation practices produce many kinds of outputs containing lessons learned, ranging from narrative reports, charts, completed forms, statistical trends or relationships, summary tables and books to bulletins, recommendation letters, check lists, training materials, and/or e-mail alerts. These outputs are derived by investigators or analysts who draw conclusions from the investigations or incident data.

At present, investigators acquire, document and report “facts” or data in many forms and formats and in many diverse and often isolated systems. This data may be used by investigators and analysts to piece together a description and/or explanation of what happened, usually in narratives or in forms, using natural language. Such accident data also forms the basis for conclusions about causes, cause factors, root causes, and other cause-oriented findings, from which investigators and analysts derive findings and recommendations. Findings and recommendations constitute the “lessons learned” from an investigation. Analysts then abstract, code, characterize, aggregate or otherwise refine and/or condense the data, findings, and recommendations. The data, findings, and recommendations are then “published” internally or made public in various kinds of media as reports, articles, papers, books, stories, graphics, training materials, check lists, etc. The data, findings, and recommendations also find their way into procedures or standards and regulations. The “published” data, findings, and recommendations may then be preserved by storage in organizational files or computerized databases for retrieval and subsequent use at a later date.

Dissemination practices vary, but generally can be categorized as electronic and non-electronic written, verbal and graphic dissemination. Electronic dissemination is achieved with computers and computerized databases, e-mails, and internet sites. Non-electronic dissemination is achieved through published or internal investigation reports, tables, checklists, on-the-job training, safety meetings, standards, training sessions, codes or regulations, and books.

Investigation data may also be used for research to develop lessons learned in the form of historical trends or statistical relationships using statistical analyses or data mining techniques. The data may also be frequently abstracted or characterized to generate lists of causes and causal factors referenced in investigation report databases, safety digests and investigation software.

There are several observed barriers to effective capture and use of investigation lessons learned. These barriers may be summarized as: (i) lessons are not routinely identified, collected and shared across organizations and industries; (ii) un-organized lessons are too difficult to use, because there is too much material to search, it may be formatted differently for different reports, it is not quickly available or work pressures do not allow time or resources to find it; (iii) reuse is rather ad hoc and unplanned; (iv) it is often hard to know what to search for or how to find useful documents; and (v) taking time to search for, identify, access and then learn from the lessons learned within an organization is a problem.

Additional impediments to developing lessons learned may be characterized as: (i) current perceptions of investigation data needs that limit data presently available for sharing; (ii) natural language barriers that lead to diverse source data content and structures, impeding identification of relevant behaviors; (iii) data that is lost due to software obsolescence; and (iv) liability concerns that motivate a desire to withhold accident data from publicly accessible sources.

Observed impediments to developing lessons learned may include data gaps, logic errors, misinterpretation or misrepresentation of observations, biased data selection, flawed assumptions, and premature conclusions during investigations.

Perceptions of what investigation data should be acquired and disseminated may be the greatest impediment to learning. Investigation purposes or mandates shape those perceptions. Investigation processes are not designed with the goal of properly informing the people who need to know the investigation results so that those people may initiate new behaviors. Currently, investigation inputs and outputs focus on determining the cause or cause factors, multiple causes, problems, and “root” causes, from which investigators or analysts infer lessons learned to report. Outputs do not provide data in a form from which individuals can derive the specific behavioral changes they need to make. In other words, the target audience is spoon-fed the new behaviors deemed desirable by the “experts,” in the form of recommendations.

The preponderance of current accident data is generally documented using natural language, rather than a “professional language” like those that exist in mathematics, music, medicine or other professional fields. This usage tolerates wide variations in the syntax, morphology, meaning, context and level of abstraction of documented investigation data thereby impeding manual analysis, machine comparisons and tabulations or rule-based manipulation like rational concatenation of elements, or interoperability, machine access and machine presentations of the data.

In these circumstances, many investigation data schemes provide accident data definition to indicate intent and improve consistency. Data improvement efforts have typically been directed at enhancing data uniformity with guides, dictionaries or glossaries or check lists, defining words and terms. However, most lack a defined data structure for data that are documented. The result is that today, almost any kind of data format and structure may be found in accident investigation findings and lessons learned, despite the increase in software applications.

Present practices also pose other impediments, including the inability to apply statistical analysis methods to derive findings from an episodic occurrence, and risks inherent in waiting for sufficient occurrences to discover valid statistical relationships.

The challenge presented in the art is to provide valid mishap-based lessons learned knowledge into the hands of the right people for their use, quickly and efficiently, to improve future performance. Ideally, lessons learned from investigations should be disseminated universally to appropriate personnel to achieve safer and better task performance.

Another challenge in the art is overcoming the natural language barriers that produce such diverse data investigation inputs and outputs, so that identified data can be produced and delivered to personnel in a form easily internalized.

Yet an additional challenge in the art is to define the structure and content of the lessons learned system. The system must satisfy user needs while also enabling enduring machine documentation, processing, remote access, interoperability, and utilization for timely, efficient presentation of readily internalized lessons learned behavioral information.

Finally, the challenges inherent in devising a comprehensive novel lessons learned system such as resources, management, staffing, control, access, and ownership must be recognized and satisfied.

### SUMMARY

To obviate the disadvantages and deficiencies of prior methods it is an object of the present subject matter to present a novel method for presenting events in an investigation. The method includes obtaining blocks of information that include a description of an action and associating the information with other information to form logical groupings. The associations include input and output action associations. The method also includes forming event sets containing the associated group which include at least an input action, a focus action or an output action and arranging the event sets in chronological order and displaying the event sets in rows over an input action column, a focus action column and an output action column.

It is also an object of the present subject matter to present a novel tabular display for events associated with an investigation. The display including a plurality of rows containing cells with descriptions of one or more associated actions, such as input actions, focus actions and output actions. The first column includes cells with the descriptions of input actions of each of the rows; the second column comprising cells with the descriptions of focus actions for each of the rows; and the third column including cells with the descriptions of output actions for each of the rows. The rows are arranged in chronological order and include empty cells where there is not an associated action description.

It is still on object of the present subject matter to present a computer-readable medium containing instructions executable by a processor to structure events in an investigation. The medium may have a series of modules for receiving blocks of information, for associating the blocks with other blocks to form logical groups such as an input action-focus action logical association and a focus action-output action logical association. The medium also may have modules for: forming event sets with the logical groups wherein each event set includes at least an input action, a focus action or an output action; arranging the event sets in chronological order; and causing a processor to display each event set in one row and over at least the input, focus and output action columns.

It is another object of the present subject matter to present a method for creating a display describing a phenomenon for investigation. The method includes obtaining information related to the phenomenon including an entity, a second action, and a description; determining a first action that precipitated the second action; and determining a third action that resulted directly from the second action. The method may also include forming a first row with the first action, the second action, and the third action; determining a fourth action that resulted directly from the third action; forming a second row with the second action, the third action, and the fourth action; and displaying the first and second rows.

These and many other objects and advantages of the present subject matter will be readily apparent to one skilled in the art to which the invention pertains from a perusal of the claims, the appended drawings, and the following detailed description of preferred embodiments

### BRIEF DESCRIPTION OF THE DRAWINGS

FIG. 1 illustrates a flow chart of a method for presenting events in an investigation according to an embodiment disclosed by the present subject matter.

FIG. 2 is a representation of the data contained in blocks of information according an embodiment disclosed by the present subject matter.

FIG. 3 is a representation of relationships between actions in neighboring rows according to an embodiment disclosed by the present subject matter

FIG. 4 is a representation of a display according to an embodiment disclosed in the present subject matter.

### DETAILED DESCRIPTION

The EBIO (Event Block Input/Output) process is a novel process which takes data defining actions by people, objects or energies describing a phenomenon or process (called “events”) and displays the data in a novel tabular form showing the necessary and sufficient inputs to each event, the event resulting from those inputs, and the subsequent action or actions produced or influenced by that event.

An EBIO process according to an embodiment of the present subject matter provides users with a novel way to structure and display data that describes and explains how a phenomenon or process produces an outcome, and to define additional data which are needed to complete a description and explanation of the phenomenon or process to identify candidate interactions that might be changed to achieve better performance. Embodiments may also assess task progress during an analysis or investigation of a phenomenon or process, assess the quality of a description or explanation of a phenomenon or process, and maximize the discovery, capture and documentation of lessons learned from the analysis or investigation.

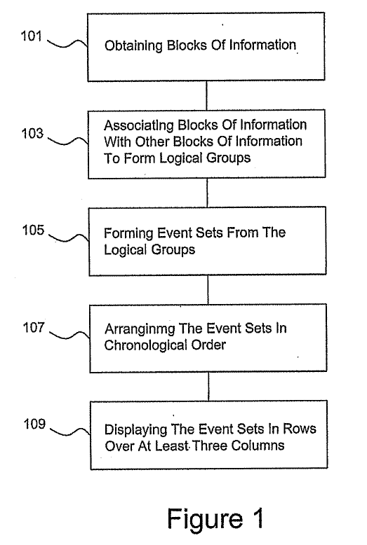

FIG. 1 is a flow chart representing an exemplary embodiment of a method for presenting events for use in an investigation. In step 101 blocks of information may be obtained, these blocks of information may include descriptions of an action, the blocks of information may be downloaded, uploaded, or entered manually, however this list is not exhaustive and other known methods are fully contemplated. In step 103 the blocks or information may be associated with each other to form logical groups. The logical groups are generally in the form of an action and an action which results therefrom. Specifically, the logical groups may form an “input action-focus action” logical group and a “focus action-output action” logical group. The “input action-focus action” logical group may include an action that serves as an input which leads to the focus action. Correspondingly, the “focus action-output action” logical group may include the focus action and the action which resulted from the focus action.

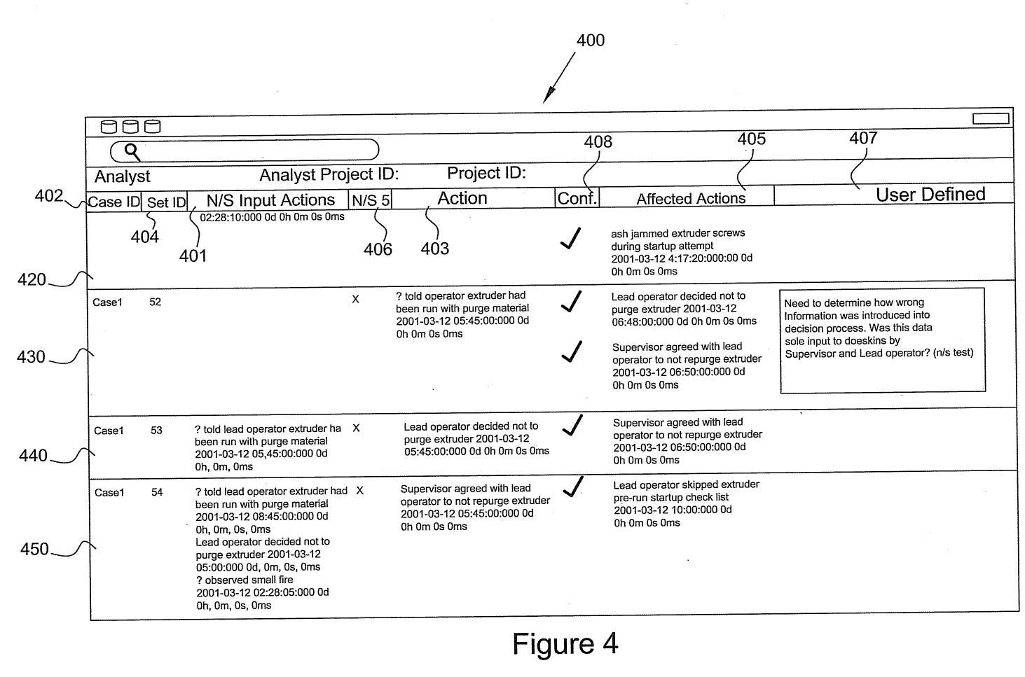

In step 105 the logical groups may be formed into event sets. For example, with reference to FIG. 4, an input action-focus action logical group may include “someone told lead operator extruder had been run with purge material” and “lead operator decided not to purge extruder”. Additionally a focus action-output action logical group may include “lead operator decided not to perge extruder” and “supervisor agreed with lead operator not to re-purge extruder”. These two logical groups may be arranged to form an event set including the input action, focus action and output action as seen in row 440 of FIG. 4. These exemplary logical groups are also arranged to form the event sets rows 430 and 450. These event sets rows are then arranged in chronological order. The chronological order may preferably be based upon the time of occurrence of the focus action; however, the time of occurrence of the input action or output action may also be used when beneficial. The events sets are then displayed in rows over at least the three columns of input action, focus action and output action as shown in step 109 of FIG. 1 resulting in part of the display as shown in FIG. 4.

During a typical investigation, investigators create “building blocks” or blocks of information used to construct a description of what happened and an explanation of why an event happened. Many kinds of building blocks exist for this purpose, including building blocks created for investigation software.

The building blocks define for investigators the format and grammar for documenting observations during investigations. By transforming an investigator's observations into this actor+action-based building block format, behaviors can be properly described, ordered, linked, tested and utilized to illustrate a logical flow of the interactions needed to produce appropriate outcomes of interest. These manual investigation building block data elements may be configured in, for example, an XML document structure offering relatively easy reliable data entry and consistency, file content flexibility, and investigation data entry editing, access, search, parsing, linking, integration and display ease. Other formats and protocols are also contemplated and the use of XML as an example should not be viewed as limiting the scope of the claims appended herewith.

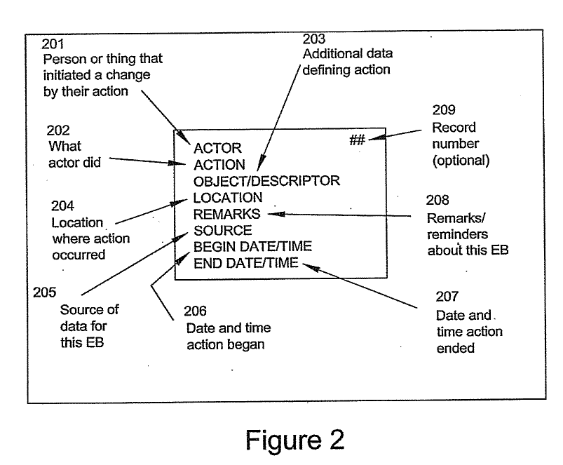

FIG. 2 shows a record or block or information which describes an action. The block of information preferably includes an actor field 201. The actor field includes the person or object that initiated a change by their action. With continued reference to FIG. 4, the focus action in row 440 contains the “lead operator” in the action field. Field 202 may include what action the actor took. Field 203 may include an object/descriptor which is generally additional data defining the action. The location field 204 includes the location where the action occurred, the begin and end fields 206 and 207 include the times in which the action began and ended, and remarks field 208 may include remarks or reminders about the event building block. Any number of blocks of information also may include a record number.

It should be noted that conditions are not included as elements; rather, all the elements and attributes refer to behavior events. Conditions may remain unchanged until someone or something acts on a condition to change it. Therefore, conditions may not be a field in themselves but may be dicta in other fields.

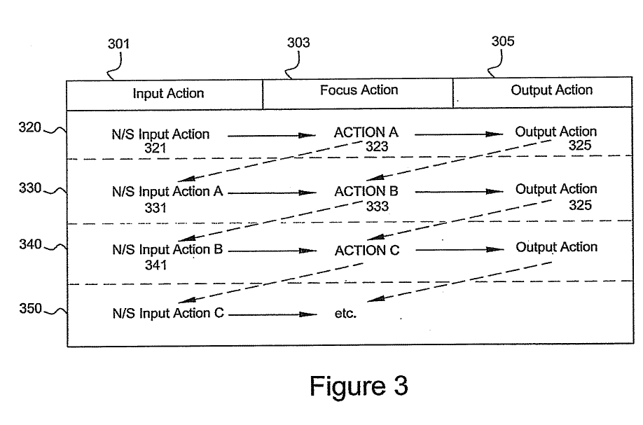

FIG. 3 is an example of forming subsequent event sets from the preceding event sets. In FIG. 3, three columns are shown: the input action column 301, the focus action column 303, and the output action column 305. The first row is 320, the second row, 330 and third and forth rows 340, 350 respectively. Rows are displayed roughly in the chronological order of occurrence. Each row after the first is created by shifting the output action from the preceding row to the focus action of the current row, further all relevant input actions, output actions and attributes may be added in the row to complete the data set in that row. For example, after the first row 320 is formed, a second row 330 may be formed. Row 330 may be formed by taking the output action 325 and making it focus action B 333 in row 330. Likewise focus action A 323 from row 320 may be placed as an input action 331 in row 330. This process may be repeated until all event sets have been established.

FIG. 4 is an exemplary display from a work file for analyzing an accident investigation report published in an investigation guide illustrating an exemplary EBIO structure. Each row may contains an entry capability for each column. The entries in a row constitute an event set. Each event set may comprise the inputs for the focal event, the focal event, focal event outputs, logic test status information, start time confirmation, and other attributes and comments as a user may desire for each event set. The display in FIG. 4 may include the input action column 401, the focus action column 403 and the output or “Affected Actions” column 405. Along with the action columns the display may include columns representing the Case ID 402 which may be an alpha-numeric identifier for the phenomenon or process being analyzed. The Set ID 404 may be a sequentially ordered number to identify each row of the display for quick reference as the analysis progresses or is used. The N/S 406 may indicate the status of the necessary and sufficient logic testing of the link between each input event and the event, which follows. The confirmation column 408 may indicate that the times the focal event began has been confirmed, or other attributes as a user may desire and the comment column 407 may be employed to add comments or notes at the end of a row. The comment column 407 may be subdivided to provide for the entry of additional data about the focal event. FIG. 4 shows four event sets in rows 420, 430, 440 and 450.

The graphic, tabular and displays created from the blocks of information may help investigators during investigations by displaying the flow of coupled events created from the investigation data already acquired. Any gaps in the flow of the events indicates a need for better understanding (more data) to complete the investigation. For example in row 430 a lack of information about the input action that led to the focus action “told operator extruder had been run with purge material” provides a gap in the flow of inputs and outputs which needs to be resolved before the investigation is closed, as indicated by the investigator's comments. When the gaps are closed, the input-output flow should define how those behaviors advanced the mishap process. The flow offers guidance for interviewers by showing what an actor did during the accident process, with gaps indicating behaviors not yet identified.

This exemplary EBIO display provides a way to disseminate investigation “lessons learned” data, although in an unconventional, high information intensity format. Each input/behavior/output event set offers a concrete description of part of a mishap process, which, if replicated can play a role in another accident or near miss and no expert interpretations are needed. Concatenated case files can identify event set patterns within or across activities. Access to such data should help all with a need to know, including writers of specifications, procedures, standards, regulations, guides and training materials. Repeated access should also facilitate the behavior change process.

A complete description of the phenomenon or process should show all the completed event sets needed to produce the final outcome. Any focal events without inputs may indicate a data gap in the understanding of a phenomenon or process and define data still needed. Any incomplete status notation for the necessary and sufficient logic test before a focal event indicates potentially incomplete input event data. Any incomplete attribute symbols may indicate uncertainties about the logic, order or other aspects of the data. Each event set may provide an opportunity to consider possible changes that might serve an analyst's needs.

When the information arranged by the EBIO process is posted, individuals can search files concatenated from many cases for event sets involving their tasks and see behavior sets to avoid or modify. This direct association and recurrent accessibility facilitates internalization of the lessons displayed and their use.

The EBIO process may be implemented with software, and additional software or hardware may be used to generate graphic event flow charts, glossaries, input-output links among two or more coupled event sets, jump maps, sortable tabular event set displays, and parsed text files. The tabular display may be embodied as a web page, a display screen, a computer screen, a projection, or in print.

The ability to easily concatenate event building block files, including the set of event sets, permits concurrent conduct of investigation tasks and individual file preparation duties by two or more investigators. Their data files can be combined into one project file as new contributions become available. When more investigations are documented, aggregated data files for groups of investigations may be created. The aggregated files enable tabular listings of event building blocks, which can be screened to find common event building blocks across incidents in a new file with detailed information about each building block's inputs and outputs in the file.

The behavior inputs necessary to produce a mishap outcome may also be displayed in a systems-based tabular form, in the sequence they occurred. This searchable display provides inputs to each behavior disclosed by the investigation, and also outputs produced by each behavior.

An exemplary EBIO process may also be implemented with a software application utilizing the event or actor/action data to develop the tabular display described. Preferably, the software application may also include the ability to edit entries and perform other display or information customization, such as hiding columns, changing display size, column width, etc.

An aspect of the present subject matter offered by this process is the arraying of investigation data to expose unknowns during and after investigations. Empty or incomplete cells in the sets (rows) define unknowns. The process provides a “research defining” method. The exposed blank or incomplete cells highlight additional data that needs to be completed in the description of the behaviors that produced the outcome.

Another aspect of the present subject matter is the universal application of exemplary methods according to the described embodiments. The methodology presented is applicable to any kind of investigation where the behaviors that produced an outcome requires understanding. Exemplary methods may support investigations of accidents, fires, explosions, hazard and risk analyses, environmental episodes, biogenetics research, climate model development, etc. The present subject matter is described in terms of an accident for illustrative purposes and should not be read as limiting the scope of the disclosure or claims.

Yet another aspect of the present subject matter is that empty or incomplete cells in the displays enable an objective quality assurance process which is presently lacking in conventional investigation processes. Any logically incomplete or dubious links in the display indicate potential quality deficiencies with either the data or the investigation methodology or its execution.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

What we claim is:

1. A method for presenting events in an investigation comprising:
obtaining blocks of information, wherein said blocks of information comprise at least a description of an action;
associating ones of said blocks with others of said blocks of information to form logical groups, wherein the associations are selected from the group consisting of an input action-focus action association and a focus action-output action association
forming event sets containing at least one of the logical groups; wherein each event set includes at least an input action, a focus action or an output action;
arranging said event sets in chronological order;
displaying each event set in one row and over at least an input action column, a focus action column and an output action column, wherein the respective actions if any are displayed in the respective column.

2. The method of claim 1, wherein, if an event set includes a focus and an output action, generating another event set which includes at least the focus action of the event set as the input action of the another event set and the output action of the event set as the focus action of the another event set.

3. The method of claim 1, wherein the chronological order is based on the time of occurrence of one of the input action, the focus action or the output action.

4. The method of claim 1, wherein columns are left blank in rows where the event sets do not include the respective actions.

5. The method of claim 1, comprising the step of assigning an identifier associated with the investigation to each of the event sets.

6. The method of claim 1, comprising the step of assigning a number corresponding to the chronological order of the event set to the event set.

7. The method of claim 1, wherein each of the blocks of information comprise at least an actor, action and description.

8. The method of claim 7, wherein each of the blocks of information further comprise at lease a beginning time.

9. The method of claim 1, wherein each of the blocks of information comprise an object, action and description.

10. The method of claim 1, wherein the investigation is selected from the group consisting of an accident, hazard, risk, or research inquiry.

11. The method of claim 5, further comprising the step of merging of event sets associated with another investigation and display the merged event sets.

12. The method of claim 4, wherein the columns with blank rows are flagged.

13. The method of claim 1, further comprising the step of verifying the associations.

14. A tabular display for events associated with an investigation, comprising:
a plurality of rows each row containing cells with descriptions of one or more associated actions, wherein the associated actions are selected from the group consisting of an input action, a focus action and an output action;
a first column comprising cells with the descriptions of input actions of each of the plurality of rows;
a second column comprising cells with the descriptions of focus actions for each of the plurality of rows;
a third column comprising cells with the descriptions of output actions for each of the plurality of rows;
wherein the plurality of rows are arranged in chronological order based on the time of occurrence of one of the input, focus or output actions, and
wherein ones of the plurality of rows without descriptions of each of the one or more associated actions include empty cells for the respective one or more associated actions.

15. The tabular display according to claim 14, comprises a fourth column containing cells with user comments associated with the row.

16. The tabular display according to claim 14, comprising a fifth column containing cells with symbols indicating status of the associated actions in the row.

17. The tabular display according to claim 14, wherein for each row with a focus and output action, a following row includes the focus and output actions in the input and focus columns respectively.

18. The tabular display according to claim 14, comprising a sixth column containing cells with symbols indicating an attribute of the associated actions in the row.

19. The tabular display according to claim 14, comprising a seventh column containing cells with an identifier associated with the investigation in the row.

20. The tabular display according to claim 14, comprising an eighth column containing a cell with an identifier associated with the chronological position of the row.

21. The tabular display according to claim 14, wherein the investigation is selected from the group consisting of an accident, hazard, risk, or research inquiry.

22. The tabular display according to claim 14, wherein the first, second and third columns are aligned left to right respectively.

23. The tabular display according to claim 14, wherein the rows containing a specific actor or object named in the focus action are highlighted in all other rows.

24. The tabular display according to claim 14, wherein the display is a consolidated tabular display that includes actions from two or more investigations.

25. A computer-readable medium containing instructions executable by a processor comprising:
a first module for receiving blocks of information, wherein said blocks of information comprise at least a description of an action;
a second module for associating ones of said blocks with others of said blocks of information to form logical groups, wherein the associations are selected from the group consisting of an input action-focus action logical association and a focus action-output action logical association;
a third module for forming event sets with one or more of the logical groups; wherein each event set includes at least an input action, a focus action or an output action
a fourth module for arranging said event sets in chronological order; and
a fifth module for causing a processor to display each event set in one row and over at least an input action column, a focus action column and output action column, wherein each respective action of a row is displayed the respective column.

26. The computer readable medium of claim 25, wherein if an event set includes a focus and an output action, the third module comprises instructions to generates another event set which includes at least the focus action as the input action and the output action as the focus action.

27. The computer readable medium of claim 25, wherein the chronological order is based on the time of occurrence of one of the input, focus or output actions.

28. The computer readable medium of claim 25, wherein corresponding columns are left blank in rows where the event sets do not include the respective actions.

29. The computer readable medium of claim 25, comprising a fifth module for editing the associations by a user.

30. The computer readable medium of claim 25, comprising a sixth module for assigning an identifier associated with the investigation to each of the event sets.

31. The computer readable medium of claim 25, comprising a seventh module for assigning a number corresponding to a chronological position of the event set to the event set.

32. The computer readable medium of claim 25, wherein each of the blocks of information comprise an actor, action and description.

33. The computer readable medium of claim 25 wherein each of the blocks of information comprise an object, action and description.

34. The computer readable medium of claim 25, further comprising another module for searching the event sets or actions.

35. The computer readable medium of claim 25, further comprising another module for concatenating displays from two or more investigations into a single display.

36. A method for creating a display describing an phenomenon for investigation comprising:
obtaining information related to the phenomenon, wherein said information comprises at least an entity, a second action and a description;
determining a first action that precipitated the second action;
determining a third action that resulted directly from the second action;
forming a first row comprising in order the first action, the second action and the third action;
determining a fourth action that resulted directly from the third action;
forming a second row comprising in order the second action, the third action and the fourth action; and
displaying the first and second rows.

37. The method of 36, comprising appending an identifier associated to the phenomenon to the first and second rows.

38. The method of 36, comprising appending a first identifier and a second identifier to the first and second rows respectively; wherein the first and second identifier reflect the chronological positions of the first and second rows.

39. The method of 36, comprising the step of verifying the first action precipitated the second action and upon verification appending a verification symbol to the first row.
